(19) United States
(12) Patent Application Publication
(10) Pub. No.: US 2020/0301493 A1
(43) Pub. Date: Sep. 24, 2020

(54) PHOTOVOLTAIC SYSTEM AND INVERTER HAVING A COMMUNICATION INTERFACE

(71) Applicant: SMA Solar Technology AG, Niestetal (DE)

(72) Inventors: Stefan Buchhold, Lohfelden (DE); Jens Friebe, Vellmar (DE); Michael Kotthaus, Niestetal (DE); Ephraim Moeser, Fuldatal (DE); Torsten Soederberg, Soehrewald (DE); Thomas Wappler, Guxhagen (DE)

(21) Appl. No.: 16/893,250

(22) Filed: Jun. 4, 2020

Related U.S. Application Data
(63) Continuation of application No. PCT/EP2018/083758, filed on Dec. 6, 2018.

(30) Foreign Application Priority Data
Dec. 6, 2017 (DE) 10 2017 129 082.6

(51) Int. Cl. G06F 1/26; G06F 13/42

(52) U.S. Cl. CPC G06F 1/266; G06F 2213/0042; G06F 13/4282

(57) ABSTRACT

The application relates to a photovoltaic system having a photovoltaic generator, an inverter and a communication interface configured for connecting an external electrical unit. The communication interface is configured for bidirectional power interchange with the external electrical unit. The inverter can include the communication interface. Furthermore, the description relates to a method for operating such a photovoltaic system.

### CROSS REFERENCE TO RELATED APPLICATIONS

This application is a continuation of International Patent Application number PCT/EP2018/083758, filed on Dec. 6, 2018, which claims priority to German Patent Application number 10 2017 129 082.6, filed on Dec. 6, 2017, and is hereby incorporated by reference in its entirety.

### FIELD

The disclosure relates to a photovoltaic system that comprises a photovoltaic generator, an inverter and a communication interface for connecting an external electrical unit, more particularly an energy storage. Furthermore, the disclosure relates to an inverter for a photovoltaic system and to a method for operating a photovoltaic system.

### BACKGROUND

A photovoltaic system can generate electric power and feed it to an AC grid. To this end, a conventional photovoltaic system comprises an inverter configured to convert a DC current into an AC current. The DC current can be generated by a DC generator, more particularly by a photovoltaic generator, which is connected to the DC side of the inverter. The AC grid can be in the form of a public power supply grid, in the form of a local grid of a company or household, or in the form of an island grid without a connection to a public power supply grid, and can be connected to the AC side of the inverter.

Conventional inverters for photovoltaic systems do not have a power supply of their own, but rather obtain an operating power required for their operation from a connected photovoltaic generator and/or from a connected AC grid. To this end, these inverters normally comprise a power supply unit, a rectifier and/or a DC-DC converter, in order to convert a DC or AC voltage applied to the DC or AC side of the inverter into an electric power suitable for operating the electrical and electronic subassemblies of the inverter.

DE202006020751 U1 discloses an inverter that comprises a communication interface to which an external electrical unit can be connected, wherein the external electrical unit can comprise a data memory and an electrical storage, more particularly a storage battery. When the external electrical unit is connected, the inverter can be supplied with electric power by the electrical storage via the communication interface, so that, even without another DC- or AC-side supply, the inverter can be operated at least to the extent that data from the data memory can be transmitted to the inverter. This data transmission can more particularly be used for performing software updates in the inverter.

A person skilled in the art is familiar with communication interfaces that comprise ports based on what is known as the USB (universal serial bus) standard. Such communication interfaces are configured both to interchange data between the devices connected via a USB cable and to transmit electric power from one device to another device via the USB cable.

### SUMMARY

The disclosure is directed to a photovoltaic system that, without a supply of electric power from sources connected to the DC or AC side of an inverter of the photovoltaic system, can be operated at least such that communication with components of the photovoltaic system, more particularly with the inverters thereof, is rendered possible.

A photovoltaic system comprises a photovoltaic generator, an inverter and a communication interface configured to connect an external electrical unit. The communication interface is configured for bidirectional power interchange with the external electrical unit. This allows the photovoltaic system to use the communication interface both to communicate with the external electrical unit and to feed energy to the external electrical unit as well as to obtain energy from the external electrical unit. A separate interface for obtaining or buffer-storing electrical energy can therefore be dispensed with.

The communication interface can in one embodiment comprise a USB port. Universal serial bus, USB for short, is a standardized technology used by millions worldwide, many devices having USB ports that are already fundamentally able to be used to transfer electric power. Such devices having USB ports are suitable as an external electrical unit for a photovoltaic system according the disclosure if they can both draw and deliver electric power.

The communication interface can in one embodiment be arranged in the inverter or in a grid connection unit of the photovoltaic system. These components normally already contain electrical and electronic subassemblies and are located in the power path of the electric power that is generated by the photovoltaic generators and fed from the inverter, for example via the grid connection unit, to an AC grid, wherein the inverter of the photovoltaic system may influence the flow of power along this power path. Moreover, data processing and communication means may be arranged in the inverter, for example processors for controlling the operation of the inverter and hence also the behaviour of the photovoltaic system as a whole.

In one embodiment, the communication interface is configured to draw an electric power from the connected external electrical unit, in order to supply components of the photovoltaic system with said electric power. This allows an inverter to be supplied with an electric power needed for operating the inverter directly from an external electrical unit connected to said inverter. Alternatively or additionally, multiple inverters of a photovoltaic system, which are connected to the AC grid via a common grid connection unit, can be supplied with electric power for their operation centrally from an external electrical unit connected to the grid connection unit. In this case, it can suffice to make so much electric power available to the respective inverter that communication with the inverter is rendered possible. This is advantageous if no electric power is available on the DC- or AC-side connections of the inverter, for example at night, when the photovoltaic generators connected to the DC side of the inverter deliver no power, or when the AC grid connected to the AC side of the inverter has failed or is disconnected from the photovoltaic system, or when the photovoltaic system was switched off after an error, or the like.

In one embodiment, the external electrical unit can comprise an energy storage, for example, a rechargeable battery, wherein the communication interface is configured to feed an electric power to the energy storage. This makes it possible to ensure that the energy storage contains an electric charge that can be produced and maintained via the communication interface.

In one embodiment, the bidirectional power interchange via the communication interface can be produced by virtue of the communication interface comprising a bidirectional voltage converter. The bidirectional voltage converter can in one embodiment comprise a two-quadrant converter, for example a step-up-step-down converter, or a four-quadrant converter, for example a bidirectional inverter. This allows a voltage to be provided on the communication interface that, depending on the desired direction of power flow, is set such that electric power is fed from the inverter or the grid connection unit to the external electrical unit or obtained by the inverter or the grid connection unit from the external electrical unit via the communication interface.

An inverter according to the disclosure for a photovoltaic system comprises a communication interface configured to connect an external electrical unit. The communication interface is configured for bidirectional power interchange with the external electrical unit. The communication interface can in one embodiment comprise a USB port to which the external electrical unit is connectable.

In one embodiment of the inverter according to the disclosure, the communication interface is configured to draw an electric power from a connected external electrical unit, in order to supply the inverter with said electric power, and to feed an electric power to the connected external electrical unit, wherein the external electrical unit comprises an energy storage, for example, a rechargeable battery. To this end, the communication interface can comprise a bidirectional voltage converter, wherein in one embodiment the bidirectional voltage converter comprises a two-quadrant converter, which can more particularly be embodied as a step-up-step-down converter. This allows the inverter firstly to feed electric power to the energy storage and secondly to take electric power from the energy storage, for example, in order to be started up without another supply, via the communication interface.

A method according to the disclosure for operating a photovoltaic system having a photovoltaic generator, an inverter and a communication interface configured to connect an external electrical unit. In the method an energy storage is connected to the communication interface and electric power is interchanged with the energy storage bidirectionally via the communication interface. In one embodiment, the method according to the disclosure can involve components of the photovoltaic system being operated using an electric power obtained from the energy storage via the communication interface, for example, if the photovoltaic generators are not connected or do not provide sufficient electric power for operating the components. Furthermore, an electric power can be fed to the energy storage, for example, if the energy storage has an energy content below its maximum energy content and the photovoltaic generators provide an electric power that exceeds the electric power needed for operating the components of the photovoltaic system. This allows operation of the photovoltaic system to be ensured at any time at least to the extent that components of the photovoltaic system, for example, the inverters and possibly further electrical or electronic devices such as sensors or switching elements, are supplied with electric power, in order to be able to communicate with these components or devices, for example for the purpose of parameterization, startup or software update.

### BRIEF DESCRIPTION OF THE FIGURES

The disclosure is explained and described in more detail below on the basis of example embodiments depicted in the figures.

FIG. 1 shows a first embodiment of a photovoltaic system according to the disclosure, and

FIG. 2 shows a second embodiment of a photovoltaic system according to the disclosure.

### DETAILED DESCRIPTION

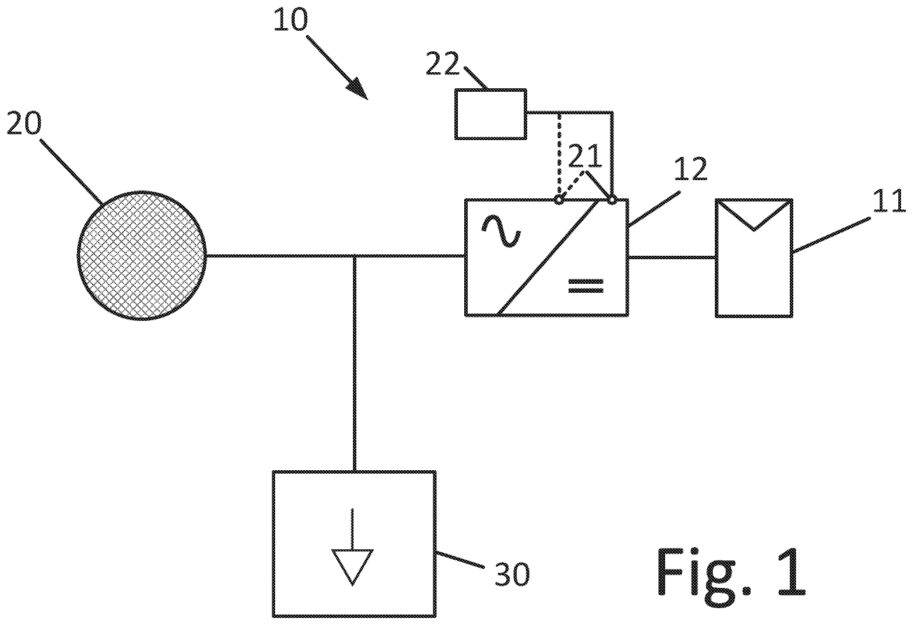

FIG. 1 shows a photovoltaic system 10 connected to an AC grid 20. The photovoltaic system 10 comprises a photovoltaic generator 11, which may comprise one PV module or a plurality of PV modules in multiple parallel- and/or series-connected strings. The photovoltaic generator 11 is connected to an inverter 12. The inverter 12 converts a DC current generated by the photovoltaic generator 11 into AC current and feeds the generated AC current to the AC grid 20. The AC grid 20 can have a load 30 connected to it, which comprises one or more consumers, for example, wherein the load 30 can more particularly be connected in close proximity to and in parallel with the inverter 12 to the same part of the AC grid 20, so that the load 30 can be partly or fully supplied with electric power from the AC grid 20 or by the inverter 12.

The inverter 12 comprises a communication interface 21. The communication interface 21 can have an external electrical unit 22 connected to it. The inverter 12 can use the communication interface 21 to interchange both data and electric power with the external electrical unit 22 bidirectionally.

The inverter 12 normally comprises a generator-side DC part and a grid-side AC part, which may be separate from one another, at least physically and possibly also electrically. The inverter 12 can be embodied such that an electric operating power needed for operating the inverter 12 is taken exclusively from the DC part, the DC part in turn being supplied with electric power exclusively by the connected photovoltaic generator 11. In this case, the inverter 12 is in an operating state only if the photovoltaic generator 11 generates sufficient electric PV power and makes it available to the DC part of the inverter 12.

The inverter 12 of the photovoltaic system 10 according to the disclosure can be supplied with the electric operating power needed for operating the inverter 12 by the external electrical unit 22 via the communication interface 21. The external electrical unit 22 may be connected directly to the AC grid 20 via a power supply unit, e.g. a rectifier, and fed by the AC grid 20. In one embodiment, the external electrical unit 22 comprises an energy storage from which the operating power of the inverter 12 can be drawn. In one embodiment, the energy storage of the external electrical unit 22 can be charged by the inverter 12 via the communication interface, for example, if the available PV power (significantly) exceeds the operating power of the inverter 12.

During normal operation, the inverter 12 obtains its operating power from the photovoltaic generator 11 and feeds the PV power exceeding the operating power, minus any switching and filter losses, to the AC grid 20. Some of the PV power can be used to charge or to maintain the charge of the energy storage in the external electrical unit 22. To this end, the communication interface 21 can comprise a bidirectional voltage converter, for example a step-up-step-down converter or a two-quadrant converter, which controls a flow of power between the inverter 12 and the external electrical unit 22, more particularly by suitably setting its relative input and output voltages.

If the PV power is not sufficient for operating the inverter 12, for example at night or in the event of a fault in the photovoltaic generator 11 or in individual parts thereof or after an error-induced shutdown of the inverter 12, the inverter 12 can be started up by virtue of the operating power of the inverter 12 being taken from the external electrical unit 22 via the communication interface 21. This allows the inverter 12 to be started up in the event of excessively low PV power and even without any PV power at all. This is useful in order to allow a communication with the inverter 12, for example in order to read data from the inverter 12 or to upload data into the inverter 12.

The communication interface 21 can be arranged on the DC part of the inverter 12 and additionally or alternatively on the AC part of the inverter 12; this arrangement is depicted in dashed lines in FIG. 1. An arrangement of the communication interface 21 on the DC part of the inverter 12 allows operation of the inverter 12 if the inverter 12 obtains its operating power from the connected photovoltaic generator 11 and there is no, or excessively low, PV power. An alternative arrangement of the communication interface 21 on the AC part of the inverter 12 allows operation of the inverter 12 if the inverter 12 obtains its operating power from the AC grid 20 and the connection to the AC grid 20 is interrupted or other errors in the AC grid 20 occur.

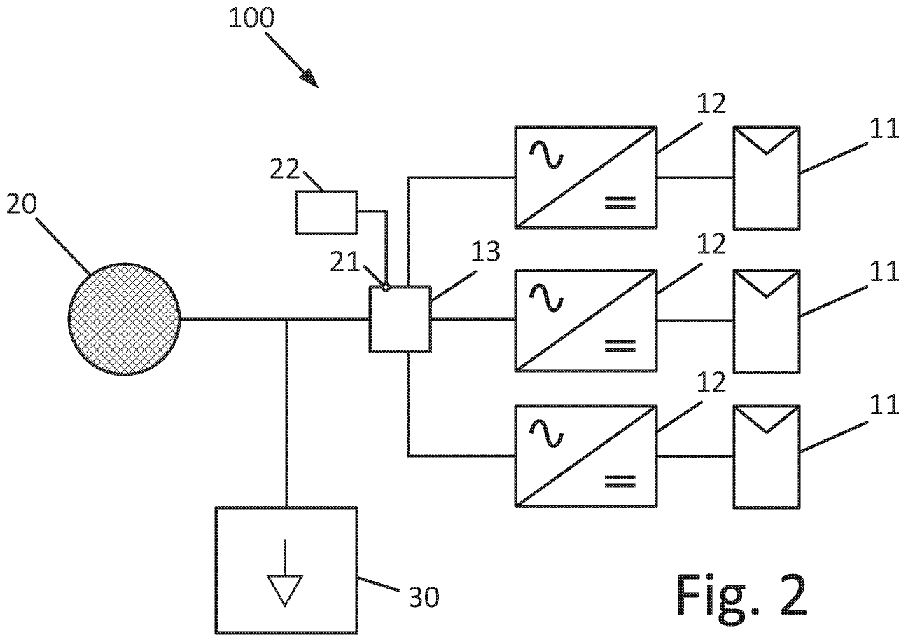

FIG. 2 shows a further embodiment of a photovoltaic system 100 according to the disclosure, in which multiple photovoltaic generators 11 are each individually connected to multiple inverters 12. The photovoltaic generators 11 can again consist of one PV module or can comprise multiple, parallel- and/or series-connected, PV modules. The inverters 12 convert the DC current generated by the respectively connected photovoltaic generator 11 into AC current and feed the generated AC current to the AC grid 20. The inverters 12 are each connected to a grid connection unit 13, wherein the grid connection unit 13 can be designed to perform various monitoring and protection functions such as grid monitoring, overload or overvoltage protection and/or potential shifting. Furthermore, the grid connection unit 13 can be configured for communication with the inverters 12 and for controlling the latter, so that for example the electrical behaviour of the inverters 12 in terms of reactive power, control power and/or other electrical parameters can be controlled via the grid connection unit 13. To this end, the grid connection unit 13 may be configured for communication with external communication partners, for example with measuring points, home automation systems or grid control rooms. For communication between the grid connection unit 13 and the inverters 12, various known methods are suitable, for example using the AC lines between the inverters 12 and the grid connection unit 13 (what is known as powerline communication) or using separate communication lines or by radio.

The grid connection unit 13 has a communication interface 21 to which an external electrical unit 22 is connectable. The grid connection unit 13 can use the communication interface 21 to interchange both data and electric power with a connected external electrical unit 22 bidirectionally. More particularly, the external electrical unit 22 can comprise an electrical energy storage that can be charged and discharged by the grid connection unit 13 via the communication interface 21. To this end, the grid connection unit 13 can comprise a bidirectional voltage converter, for example, a four-quadrant converter, that controls a flow of power between the grid connection unit 13 and the external electrical unit 22. To this end, such a four-quadrant converter can convert an AC voltage provided by the AC grid 20 and tapped off in the grid connection unit 13 into a DC voltage that can be used for charging the energy storage in the external electrical unit 22. Conversely, the four-quadrant converter can convert a DC voltage provided by an energy storage in the external electrical unit 22 into an AC voltage that can be impressed onto AC lines inside the grid connection unit 21, in order to generate an AC current in the AC lines. It goes without saying that such rectified operation of the four-quadrant converter in the grid connection unit 12 comprises substantially lower powers than the maximum power of the AC current of the photovoltaic system 100 that is generated from the photovoltaic generators 11 by the inverters 12, and that the four-quadrant converter can accordingly be designed to be much smaller than the inverters 12.

In the event of a failure of the AC grid 20, the inverters 12 can be automatically shut down. If the photovoltaic system 100 is disconnected from the AC grid 20 manually, for example for maintenance reasons or by a fire brigade in a hazard situation, the photovoltaic generators 11 may be disconnected from the inverters 12 of the photovoltaic system 100 as well, in particular when standards require the whole photovoltaic system 100 being de-energized in such cases. To this end, switching elements, not depicted here, between the AC grid 20 and the inverters 12 and/or between the inverters 12 and the respective photovoltaic generators 11 can be operated, so that the inverters 12 are no longer able to obtain their operating power, neither from the DC nor from the AC side. Even the grid connection unit 13 may have no electric power available in this case. Furthermore, without an AC voltage being present at the AC-side, a line-commutated inverters 12 cannot operate due to a missing voltage reference signal required for feeding power into the AC grid 20.

In a photovoltaic system 100 according to the disclosure, an electric power can be taken from the external electrical unit 22 via the communication interface 21. In particular under the circumstances described above, this electric power can be used to apply a DC voltage and/or an AC voltage to the AC lines between the grid connection unit 13 and the inverters 12 by means of a voltage converter, for example, by means of a four-quadrant converter. A corresponding DC voltage or AC voltage can be used to transmit an electric power to the inverters 12, said electric power being suitable for operating the inverter 12. This is particularly useful in order to allow a communication with the inverter 12, for example in order to read data from the inverters 12 or to upload data into the inverters 12. This also allows for triggering a (re)starting process of the photovoltaic system 100. A corresponding AC voltage can be used as a voltage reference signal for the line-commutated inverters 12 and/or can mediate a transmission of an operating power from the external electrical unit 21 to the inverters 12.

A photovoltaic system 10 or 100 according to the disclosure can be used advantageously in the following configurations.

An external power supply unit that makes an electric power available to the inverter 12 shown in FIG. 1 or to the grid connection unit 21 shown in FIG. 2 can be connected to the communication interface 21. This electric power can be used to put the inverter(s) 12 into an operating state that allows at least a communication with a control unit in the inverter 12. If the communication interface 21 comprises a USB port, this allows a commercially available charger, a plug power supply unit or a USB output of a portable computer to be used to program, configure, initialize and/or start up a photovoltaic system 10, 100, for example, before a freshly installed photovoltaic system 10, 100 has been connected to the AC grid 20 and/or before a photovoltaic generator 11 has been connected to one of the inverters 12.

The communication interface 21 can alternatively or additionally be used for outputting electric power. In this case, the inverter 12 in the embodiment shown in FIG. 1 or a bidirectional voltage converter in the grid connection unit 13 makes a reasonable electric power available, which, depending on the embodiment of the communication interface 21, may be between 0.5 watt and 100 watts. If the communication interface 21 comprises a USB port embodied according to the USB-PD (USB power delivery) specification, up to 100 watts can be transmitted to an external electrical unit 22 via the communication interface 21; this is sufficient for supplying power to external small devices and for charging a small to medium-sized energy storage having a capacity of, e.g. up to 1000 watt hours. If not used in the photovoltaic system 10, 100, said energy storage may be removed and used elsewhere, for example in order to supply portable phones or similar devices with operating power via their USB ports and possibly to charge energy storages comprised in those devices.

If an external electrical unit 22 having an energy storage is connected to the communication interface 21, it is possible to switch between the two aforementioned configurations without action from outside. During normal operation of the photovoltaic system 10, 100, the energy storage is charged or its charge is preserved. At night and/or in the event of a failure of the AC grid 20, the same energy storage can supply electric operating power in the form of a DC or AC current and/or provide a voltage reference signal in the form of an AC voltage to the inverter 12 directly via the communication interface 21 or indirectly via the grid connection unit 13, respectively.

The external electrical unit 22 may comprise a data memory, at least some of the content of which can be transmitted to the inverter(s) 12 via the communication interface 21. This transmitted content can more particularly comprise firmware for operating the inverters 12 and/or other parameters such as nominal properties of the AC grid 20, limit values for grid voltage and grid frequency, preset values for feeding electric power to the AC grid 20, communication parameters and the like. Vice versa, data can be stored in the data memory of the external electrical unit 22 by the inverter 12 or by the inverters 12, for example power and energy values of the photovoltaic system, error messages and the like.

1. A photovoltaic system, comprising:
an inverter configured to couple to a photovoltaic generator, and
a communication interface coupled to the inverter, and configured to connect an external electrical unit,
wherein the communication interface is configured to provide bidirectional power interchange with the external electrical unit.

2. The photovoltaic system as claimed in claim 1, wherein the communication interface comprises a USB port.

3. The photovoltaic system as claimed in claim 1, wherein the communication interface is arranged in the inverter or in a grid connection unit of the photovoltaic system.

4. The photovoltaic system as claimed in claim 1, wherein the communication interface is configured to draw an electric power from the connected external electrical unit, in order to supply components of the photovoltaic system with said electric power.

5. The photovoltaic system as claimed in claim 4, wherein the communication interface is configured to feed an electric power to the external electrical unit, wherein the external electrical unit comprises an energy storage.

6. The photovoltaic system as claimed in claim 1, wherein the communication interface comprises a bidirectional voltage converter.

7. The photovoltaic system as claimed in claim 6, wherein the bidirectional voltage converter comprises a two-quadrant converter or a four-quadrant converter.

8. The photovoltaic system as claimed in claim 7, wherein the two-quadrant converter comprises a step-up step-down converter, and the four-quadrant converter comprises a bidirectional inverter.

9. An inverter for a photovoltaic system, wherein the inverter comprises a communication interface configured to connect to an external electrical unit, wherein the communication interface is configured for bidirectional power interchange with the external electrical unit.

10. The inverter of claim 9, wherein the communication interface comprises a USB port.

11. The inverter as claimed in claim 9, wherein the communication interface is configured to draw an electric power from the connected external electrical unit, in order to supply the inverter with said electric power, and to feed an electric power to the external electrical unit, and wherein the external electrical unit comprises a rechargeable battery.

12. The inverter as claimed in claim 11, wherein the communication interface comprises a bidirectional voltage converter.

13. The inverter as claimed in claim 12, wherein the bidirectional voltage converter comprises a two-quadrant converter.

14. The inverter of claim 13, wherein the two-quadrant converter comprises a step-up-step-down converter.

15. A method for operating a photovoltaic system having a photovoltaic generator, an inverter and a communication interface configured to connect an external electrical unit, the method comprising:
connecting the external electrical unit comprising an energy storage to the communication interface, and
interchanging electric power with the energy storage bidirectionally via the communication interface.

16. The method as claimed in claim 15, further comprising operating components of the photovoltaic system using an electric power obtained from the energy storage via the communication interface when the photovoltaic generator is disconnected from the inverter and/or when the photovoltaic generator does not provide sufficient electric power for operating the components.

17. The method as claimed in claim 15, further comprising feeding an electric power to the energy storage when the energy storage has an energy content below its maximum energy content and/or when the photovoltaic generator provides an electric power that exceeds the electric power needed for operating the components of the photovoltaic system.
